(19) United States
(12) Patent Application Publication
(10) Pub. No.: US 2025/0066254 A1
(43) Pub. Date: Feb. 27, 2025

(54) CARBONIZATION-RESISTANT REFRACTORY CASTABLES FOR USE IN REFRACTORY LININGS

(71) Applicant: EXXONMOBIL TECHNOLOGY AND ENGINEERING COMPANY, Spring, TX (US)

(72) Inventors: Christopher J. FOWLER, Houston, TX (US); Aleksandr E. CHERNOFF, Spring, TX (US); Patrick L. YODER, Mount Crawford, VA (US); Andrew R. WITT, Huffman, TX (US)

(21) Appl. No.: 18/809,585

(22) Filed: Aug. 20, 2024

Related U.S. Application Data
(60) Provisional application No. 63/520,681, filed on Aug. 21, 2023.

(51) Int. Cl. C04B 35/10; B01J 6/00; C01B 3/02; C10J 3/78

(52) U.S. Cl. CPC C04B 35/10; B01J 6/008; C01B 3/02; C10J 3/78; C04B 2235/3208; C04B 2235/3217; C04B 2235/723; C04B 2235/9669; C10J 2200/09

(57) ABSTRACT

A reactor useful in the production and conversion of hydrocarbon feedstocks may include: a pressure vessel with an interior wall; a refractory lining inside the reactor, wherein the refractory lining comprises: a first layer comprising a brick refractory, a second layer comprising a refractory castable, wherein the refractory castable comprises an aggregate and a binder, wherein the binder comprises CaO·6Al₂O₃ and less than 1 wt % of a hydratable calcium aluminate, and a third layer comprising a fiber refractory, wherein the second layer is between the first and third layers, and wherein the third layer is closest to the interior wall.

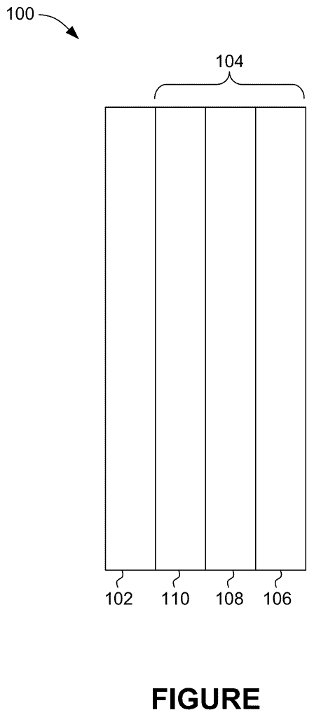

### CROSS-REFERENCE TO RELATED APPLICATIONS AND PRIORITY CLAIM

This Non-Provisional Patent application claims priority to U.S. Provisional Patent Application No. 63/520,681, filed Aug. 21, 2023, and titled “Carbonization-Resistant Refractory Castables For Use In Refractory Linings”, the entire contents of which is incorporated herein by reference.

### FIELD OF INVENTION

The present disclosure relates to the refractory lining of pressure vessels, especially, pressure vessels used in the production and conversion of hydrocarbon feedstocks.

### BACKGROUND

A gasification unit converts hydrocarbon feed into a fuel gas or syngas. Air and steam are directly contacted with the feed to create syngas and ash/slag. These reactions are favorable at elevated temperatures and pressures. A partial oxidation unit converts hydrocarbon feed into hydrogen. Similar to the gasification unit, partial oxidation reactions are favorable at elevated temperatures and pressures. Conditions in gasification and partial oxidation units may include temperatures up to 1650° K, pressures up to 60 bar, and a carbon activity of about 1 to about 50. These conditions require a refractory-lined pressure vessel.

Typically, a suitable refractory lining for a pressure vessel includes three layers. The first layer, which is the most inward layer and is exposed to the reaction environment, is brick refractory that is high-durability, low-insulating. The second layer (or middle layer) is refractory castable that is medium-durabilty, medium-insulating. The third layer, which is in contact with the pressure vessel, is a fiber refractory that is low-durability, highly-insulating.

The reaction environment can interact with the refractory castable of the second layer. The process condition in the gasification and partial oxidation units, especially in hot spots, are a favorable environment for high-temperature direct carbonation of the refractory castable. Carbonation attacks the calcium alumina cement bonding phase, which causes the refractory castable to expand and deteriorate (e.g., convert to a powder). As the refractory castable expands, the first layer of the refractory lining is cracked and pushed into the reaction area (e.g., looking like a bulge in the lining) and, potentially, pushed completely out of position

High-temperature carbonation of the refractory castable leads to unexpected failure and costly maintenance. Unexpected failure can result in hot spots, global lining collapse, or otherwise an unplanned unit shutdown. Such failures are particularly unexpected because refractory inspection is typically completed from within the pressure vessel such that only the first layer of the refractory lining can be visually inspected. Thus, maintenance can only be completed after the failure has been found by inspection and not included in planning of work during the maintenance activity.

### SUMMARY OF INVENTION

The present disclosure includes a reactor that comprises: a pressure vessel with an interior wall; a refractory lining inside the reactor, wherein the refractory lining comprises: a first layer comprising a brick refractory, a second layer comprising a refractory castable, wherein the refractory castable comprises an aggregate and a binder, wherein the binder comprises CaO·6Al₂O₃ and less than 1 wt % of a hydratable calcium aluminate, and a third layer comprising a fiber refractory, wherein the second layer is between the first and third layers, and wherein the third layer is closest to the interior wall.

The present disclosure also includes a method that comprises: introducing a hydrocarbon feedstock, an oxygen-containing gas, and, optionally, steam into a reactor, wherein the reactor comprises: a pressure vessel with an interior wall; a refractory lining inside the reactor, wherein the refractory lining comprises: a first layer comprising a brick refractory, a second layer comprising a refractory castable, wherein the refractory castable comprises an aggregate and a binder, wherein the binder comprises CaO·6Al₂O₃ and less than 1 wt % of a hydratable calcium aluminate, and a third layer comprising a fiber refractory, wherein the second layer is between the first and third layers, and wherein the third layer is closest to the interior wall; and reacting the hydrocarbon feedstock, the oxygen-containing gas, and the steam, if present, in the reactor to produce a product.

The present disclosure further includes a refractory castable that comprises: an aggregate; and a binder that comprises CaO·6Al₂O₃ and less than 1 wt % of a hydratable calcium aluminate.

These and other features and attributes of the disclosed compositions, systems, and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawing. The following FIGURE is included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

The FIGURE illustrates a cross-section of a portion of a reactor 100 that includes an interior wall 102 of the pressure vessel and a refractory lining according to at least one embodiment of the present disclosure.

### DETAILED DESCRIPTION

The present disclosure relates to the refractory lining of pressure vessels, especially, pressure vessels used in gasification and partial oxidation units. The refractory linings of the present disclosure include refractory castables that have little to not hydratable calcium aluminates. Without being limited by theory, it is believed that the hydratable calcium aluminates absorb carbon from the reaction taking place in the reactor. The absorbed carbon causes carbonation of the hydratable calcium aluminates. Such carbonation causes the refractory castable to expand and deteriorate (e.g., convert to a powder), which, in turn, causes the refractory lining of the pressure vessel to have hot spots and, potentially, fail or collapse. Advantageously, the refractory castables described herein that have little to no hydratable calcium aluminates are carbonization-resistant, which may extend the life of the refractory castable portion of the refractory lining and mitigate the need for costly and unplanned unit shutdowns.

Refractory castables are settable compositions that comprise aggregates and binders. The aggregates may be present in the refractory castable at about 60 wt % to 99 wt % (or 60 wt % to 80 wt %, or 70 wt % to 90 wt %, or 80 wt % to 99 wt %) based on a dry weight of the refractory castable. The binders may be present in the refractory castable at about 1 wt % to 40 wt % (or 20 wt % to 40 wt %, or 10 wt % to 30 wt %, or 1 wt % to 20 wt %) based on a dry weight of the refractory castable.

The aggregates are typically composed of refractory materials. Examples of materials suitable for use in the aggregates may include, but are not limited to, CaO·6Al₂O₃, hibonite, bubble alumina, the like, and any combination thereof.

Examples of binders may include, but are not limited to, CaO·6Al₂O₃, sodium hexametaphosphate, monoaluminate phosphate, alpha-alumina (α-Al₂O₃), or any combination thereof. Preferably, the binder comprises CaO·6Al₂O₃ and optionally one or more other binders.

A hydratable calcium aluminate may be present in the binder at 1 wt % or less (or 0.1 wt % or less, or 0.01 wt % to 1 wt %, or 0.01 wt % to 0.1 wt %) on a dry basis. A hydratable calcium aluminate may be absent (or not present) in the binder. Examples of a hydratable calcium aluminate may include, but are not limited to, CaO·Al₂O₃, CaO·2Al₂O₃, the like, and any combination thereof.

The refractory castable, as a whole, may comprise a hydratable calcium aluminate at 0.1 wt % or less (or 0.01 wt % or less, or 0.001 wt % to 0.1 wt %, or 0.001 wt % to 0.01 wt %) on a dry basis. A hydratable calcium aluminate may be absent (or not present) in the refractory castable, as a whole.

To produce a refractory castable of the present disclosure, the components of the refractory castable and optionally water may be mixed to form a mixture with a desired consistency. The binder may be a liquid binder and suitable for forming the mixture. Alternatively, water may be mixed with the components of the refractory castable including the aggregates and the binder (e.g., in liquid or solid form). The resulting mixture may be placed (e.g., poured like concrete, tamped or rammed into place, troweled or applied with an air gun) in a mold where the mixture sets. The setting may be facilitated and/or developed with elevated temperature (e.g., placing in an oven or other suitable apparatus at 50° C. or greater (or 50° C. to 150° C.)).

The refractory castable of the present disclosure may be produced and then shipped to the site of the reactor.

The refractory castable of the present disclosure may be at least a portion of one of the linings in a refractory lining inside a reactor. Examples of reactors may include, but are not limited to, a gasification reactor, an auto thermal reformer, a partial oxidation reactor, and the like.

The FIGURE illustrates a cross-section of a portion of a reactor 100 that includes an interior wall 102 of the pressure vessel and a refractory lining 104. The refractory lining 104 is inside the reactor 100 and includes a first layer 106, a second layer 108, and a third layer 110. The first layer 106 comprises a brick refractory and, in the illustrated example, is the innermost layer of the refractory lining 104. The second layer 108, which is between the first layer 106 and the third layer 110, comprises a refractory castable of the present disclosure. The third layer 110, which is the closest layer of the refractory lining 104 to the inner wall 102 of the pressure vessel, comprises a fiber refractory.

Each layer 106,108, 110 of the refractory lining 104 may be composed of one or more layers of their respective materials. For example, the second layer 108 may include only a single layer of refractory castable of the present disclosure. Alternatively, the second layer 108 may include two concentric layers each containing refractory castables of the present disclosure.

Each layer 106,108,110 of the refractory lining 104 may have dimensions and configurations known in the art, which may depend, at least in part, on the composition of each layer, the dimensions of the pressure vessel, and the operating conditions of the reactor.

The brick refractory of the refractory lining (e.g., contained in the first layer 106 of the refractory lining 104 of the FIGURE) and the fiber refractory of the refractory lining (e.g., contained in the third layer 110 of the refractory lining 104 of the FIGURE) may be composed of known materials known in the art, which may depend, at least in part, on the dimensions of each layer, the dimensions of the pressure vessel, and the operating conditions of the reactor.

The refractory castable of the present disclosure may be at least a portion of one of the linings in a refractory lining inside a reactor or pressure vessel used in the production and conversion of hydrocarbon feedstocks. In particular, the refractory castable may be most beneficial when the reaction occurring in the reactor or pressure vessel has a high carbon activity (e.g., 1 or greater, or 5 or greater, or 10 or greater, or 25 or greater, or 50 or greater, or 200 or greater, or 500 or greater, or 1000 or greater). It should be noted that the carbon activity of the reaction is dependent on the temperature in the reactor or pressure vessel.

Briefly, the reaction may include introducing a hydrocarbon feedstock, oxygen-containing gas, and, optionally, steam into a reactor comprising a pressure vessel with a refractory lining of the present disclosure; and reacting the feedstock with the oxygen and steam (when present) to produce (a) fuel gas comprising carbon monoxide and hydrogen and (b) ash and/or slag.

Examples of hydrocarbon feedstocks may include, but are not limited to, C1-C4 hydrocarbons, heavier (C5+) hydrocarbons, C2-C5+ olefins, C2-C5+ oxygenates, coal, biomass, coke, heavy residual oil, petroleum atmospheric distillation bottoms, petroleum vacuum distillation bottoms, pitch, asphalt, bitumen, tar sand oil, shale oil, coal slurry, coal liquefaction product (e.g., coal liquefaction bottoms), the like, and any combination thereof.

The hydrocarbon feedstock may have a Conradson Carbon Residue (ASTM D189-165) of 0 wt % to 50 wt %.

In the reaction zone, the reaction between the hydrocarbon feedstock and the steam (when present) and oxygen produces a hydrogen and carbon monoxide-containing fuel gas and a partially gasified residual product (e.g., a partially gasified residual coke product). Conditions in the pressure vessel are selected accordingly to generate these products. Steam, oxygen, and CO₂ rates will depend upon the rate at which hydrocarbon feedstock enters from the reactor and upon the composition of the hydrocarbon feedstock.

When using a solid hydrocarbon feedstock like coke, the fuel gas product from the gasifier may contain entrained solids (e.g., coke solids), which can be removed by cyclones or other separation techniques. The cyclones may be internal cyclones in the main pressure vessel itself or external in a separate, smaller vessel. The fuel gas product can be taken out as overhead from the gasifier cyclones. The resulting partially gasified residual product can be removed from the reactor and undergo further processing. For example, with coke feedstock, the partially gasified residual coke product can be removed from the reactor and introduced directly into a coking zone of a coking reactor.

The operating temperature of the reactor may be about 850° C. to about 1800° C. (about 1560° F. to about 3275° F.). The operating pressure of the reactor for a gasification process may be about 0 kilopascals gauge (kPag) to about 1000 kPag (about 0 psig to about 150 psig), preferably from about 200 kPag to about 400 kPag (about 30 psig to about 60 psig).

The reactions in the pressure vessel may, for example, be gasification reactions, auto thermal reformer reactions, partial oxidation reactions, and the like. Other reactions that fall within the foregoing conditions and carbon activity may also be performed in a reactor comprising a pressure vessel with a refractory lining of the present disclosure.

Examples of gasification processes and systems for producing fuel gas may include those disclosed in U.S. Pat. Nos. 3,480,419, 4,094,650, 4,318,712, 5,094,737, and 10,407,631, which are incorporated herein by reference.

Briefly, gasification processes may include introducing a hydrocarbon feedstock, oxygen-containing gas, and steam into a reactor (or gasifier) comprising a pressure vessel with a refractory lining of the present disclosure; and reacting the feedstock with the oxygen and steam to produce (a) fuel gas comprising carbon monoxide and hydrogen and (b) ash and/or slag.

Examples of hydrocarbon feedstocks for gasification processes may include, but are not limited to, coal, biomass, coke, heavy residual oil, petroleum atmospheric distillation bottoms, petroleum vacuum distillation bottoms, pitch, asphalt, bitumen, tar sand oil, shale oil, coal slurry, coal liquefaction product (e.g., coal liquefaction bottoms), the like, and any combination thereof. The hydrocarbon feedstock for gasification processes may have a Conradson Carbon Residue (ASTM D189-165) of at least 5 wt %, generally from about 5 wt % to 50 wt %.

A gasification process may, for example, include passing steam and an oxygen-containing gas (preferably having a low nitrogen content, such as oxygen from an air separation unit or another oxygen stream including 95 vol % or more of oxygen, or 98 vol % or more of oxygen) into the reactor for reaction with the hydrocarbon feedstock.

A separate diluent stream (e.g., a recycled CO₂ or H₂S stream derived from the fuel gas produced by the gasifier) can also be passed into the reactor. The amount of diluent can be selected by any convenient method. For example, the amount of diluent can be selected so that the amount of diluent replaces the weight of N₂ that would be present in the oxygen-containing stream if air was used as the oxygen-containing stream. As another example, the amount of diluent can be selected to allow for replacement of the same BTU value for heat removal that would be available if N₂ was present based on use of air as the oxygen-containing stream. These types of strategy examples can allow essentially the same or a similar temperature profile to be maintained in the gasifier relative to conventional operation.

In the gasification zone, the reaction between the hydrocarbon feedstock and the steam and oxygen produces a hydrogen and carbon monoxide-containing fuel gas and a partially gasified residual product (e.g., a partially gasified residual coke product). Conditions in the gasifier are selected accordingly to generate these products. Steam, oxygen, and CO₂ rates will depend upon the rate at which hydrocarbon feedstock enters from the reactor and upon the composition of the hydrocarbon feedstock.

When using a solid hydrocarbon feedstock like coke, the fuel gas product from the gasifier may contain entrained solids (e.g., coke solids), which can be removed by cyclones or other separation techniques. The cyclones may be internal cyclones in the main pressure vessel itself or external in a separate, smaller vessel. The fuel gas product can be taken out as overhead from the gasifier cyclones. The resulting partially gasified residual product can be removed from the reactor and undergo further processing. For example, with coke feedstock, the partially gasified residual coke product can be removed from the reactor and introduced directly into a coking zone of a coking reactor.

The operating temperature of the reactor for a gasification process may be about 850° C. to about 1800° C. (about 1560° F. to about 3275° F.). The operating pressure of the reactor for a gasification process may be about 0 kiloPascals gauge (kPag) to about 1000 kPag (about 0 psig to about 150 psig), preferably from about 200 kPag to about 400 kPag (about 30 psig to about 60 psig).

Examples of partial oxidation processes and systems for producing hydrogen may include those disclosed in U.S. Pat. Nos. 5,883,138, 5,886,056, 6,267,912, and 6,329,434, which are incorporated herein by reference.

Partial oxidation processes are similar to gasification processes but generally use a lighter hydrocarbon feedstock than gasification processes. Briefly, partial oxidation may include introducing a hydrocarbon feedstock, oxygen-containing gas, and steam into a reactor (or gasifier) comprising a pressure vessel with a refractory lining of the present disclosure; and reacting the feedstock with the oxygen and steam to produce (a) fuel gas comprising carbon monoxide and hydrogen and (b) ash and/or slag.

Examples of hydrocarbon feedstocks for partial oxidation may include, but are not limited to, C1-C4 hydrocarbons, heavier (C5+) hydrocarbons, C2-C5+ olefins, C2-C5+ oxygenates, the like, and any combination thereof.

Partial oxidation processes may also use catalysts. Catalyst compositions suitable for use in the catalytic partial oxidation of hydrocarbons are known in the art. Preferred catalysts may comprise, as the catalytically active component, a metal selected from Group VIII of the Periodic Table of the Elements. Said metal may be selected from nickel ruthenium, rhodium, palladium, osmium, iridium, and platinum. The catalytically active metal may be used in metallic form, as in wire mesh, metal shot, or metal monolith. If desired, one or more metals can be coated on or combined with other metals. The catalytically active metal may also be supported on suitable carrier materials well known in the art, including the refractory oxides, such as silica, alumina, titania, zirconia, the like, and mixtures thereof. Mixed refractory oxides, comprising at least two cations, may also be employed as carrier materials for the catalyst.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

Embodiment 1. A reactor comprising: a pressure vessel with an interior wall; a refractory lining inside the reactor, wherein the refractory lining comprises: a first layer comprising a brick refractory, a second layer comprising a refractory castable, wherein the refractory castable comprises an aggregate and a binder, wherein the binder comprises CaO·6Al₂O₃ and less than 1 wt % of a hydratable calcium aluminate, and a third layer comprising a fiber refractory, wherein the second layer is between the first and third layers, and wherein the third layer is closest to the interior wall.

Embodiment 2. The reactor of Embodiment 1, wherein the binder further comprises sodium hexametaphosphate, monoaluminate phosphate, alpha-alumina (α-Al₂O₃), or any combination thereof.

Embodiment 3. The reactor of any of Embodiments 1-2, wherein the binder is present at 40 wt % or less of the refractory castable.

Embodiment 4. The reactor of any of Embodiments 1-3, wherein the aggregate comprises CaO·6Al₂O₃, hibonite, bubble alumina, or any combination thereof.

Embodiment 5. The reactor of any of Embodiments 1-4, wherein the binder comprises less than 0.1 wt % of the hydratable calcium aluminate.

Embodiment 6. The reactor of any of Embodiments 1-4, wherein the binder is absent the hydratable calcium aluminate.

Embodiment 7. The reactor of any of Embodiments 1-6, wherein the hydratable calcium aluminate comprises CaO·Al₂O₃, CaO·2Al₂O₃, or any combination thereof.

Embodiment 8. A method comprising: introducing a hydrocarbon feedstock, an oxygen-containing gas, and, optionally, steam into a reactor, wherein the reactor comprises: a pressure vessel with an interior wall; a refractory lining inside the reactor, wherein the refractory lining comprises: a first layer comprising a brick refractory, a second layer comprising a refractory castable, wherein the refractory castable comprises an aggregate and a binder, wherein the binder comprises CaO·6Al₂O₃ and less than 1 wt % of a hydratable calcium aluminate, and a third layer comprising a fiber refractory, wherein the second layer is between the first and third layers, and wherein the third layer is closest to the interior wall; and reacting the hydrocarbon feedstock, the oxygen-containing gas, and the steam, if present, in the reactor to produce a product.

Embodiment 9. The method of Embodiment 8, wherein the binder further comprises sodium hexametaphosphate, monoaluminate phosphate, alpha-alumina (α-Al₂O₃), or any combination thereof.

Embodiment 10. The method of any of Embodiments 8-9, wherein the binder is present at 40 wt % or less of the refractory castable.

Embodiment 11. The method of any of Embodiments 8-10, wherein the aggregate comprises CaO·6Al₂O₃, hibonite, bubble alumina, or any combination thereof.

Embodiment 12. The method of any of Embodiments 8-11, wherein the binder comprises less than 0.1 wt % of the hydratable calcium aluminate.

Embodiment 13. The method of any of Embodiments 8-11, wherein the binder is absent the hydratable calcium aluminate.

Embodiment 14. The method of any of Embodiments 8-13, wherein the hydratable calcium aluminate comprises CaO·Al₂O₃, CaO·2Al₂O₃, or any combination thereof.

Embodiment 15. A refractory castable comprising: an aggregate; and a binder that comprises CaO·6Al₂O₃ and less than 1 wt % of a hydratable calcium aluminate.

Embodiment 16. The refractory castable of Embodiment 15, wherein the binder further comprises sodium hexametaphosphate, monoaluminate phosphate, alpha-alumina (α-Al₂O₃), or any combination thereof.

Embodiment 17. The refractory castable of any of Embodiments 15-16, wherein the binder is present at 40 wt % or less of the refractory castable.

Embodiment 18. The refractory castable of any of Embodiments 15-17, wherein the aggregate comprises CaO·6Al₂O₃, hibonite, bubble alumina, or any combination thereof.

Embodiment 19. The refractory castable of any of Embodiments 15-18, wherein the binder comprises less than 0.1 wt % of the hydratable calcium aluminate.

Embodiment 20. The refractory castable of any of Embodiments 15-18, wherein the binder is absent the hydratable calcium aluminate.

Embodiment 21. The refractory castable of any of Embodiments 15-20, wherein the hydratable calcium aluminate comprises CaO·Al₂O₃, CaO·2Al₂O₃, or any combination thereof.

To facilitate a better understanding of the embodiments of the present invention, the following examples of preferred or representative embodiments are given. In no way should the following examples be read to limit, or to define, the scope of the invention.

### EXAMPLES

A refractory castable containing CaO·Al₂O₃ in the binder was exposed to carbon dioxide and water at about 2675° F. at 600 psi. Then, the refractory castable was examined by scanning electron microscopy and elemental analysis, which showed the formation of calcium carbonate (CaCO₃). Visible inspection of the refractory castable showed degradation of the integrity of the refractory castable.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A reactor comprising:
a pressure vessel with an interior wall;
a refractory lining inside the reactor, wherein the refractory lining comprises:
a first layer comprising a brick refractory,
a second layer comprising a refractory castable, wherein the refractory castable comprises an aggregate and a binder, wherein the binder comprises CaO·6Al₂O₃ and less than 1 wt % of a hydratable calcium aluminate, and
a third layer comprising a fiber refractory, wherein the second layer is between the first and third layers, and wherein the third layer is closest to the interior wall.

2. The reactor of claim 1, wherein the binder further comprises sodium hexametaphosphate, monoaluminate phosphate, alpha-alumina (α-Al₂O₃), or any combination thereof.

3. The reactor of claim 1, wherein the binder is present at 40 wt % or less of the refractory castable.

4. The reactor of claim 1, wherein the aggregate comprises CaO·6Al₂O₃, hibonite, bubble alumina, or any combination thereof.

5. The reactor of claim 1, wherein the binder comprises less than 0.1 wt % of the hydratable calcium aluminate.

6. The reactor of claim 1, wherein the binder is absent the hydratable calcium aluminate.

7. The reactor of claim 1, wherein the hydratable calcium aluminate comprises CaO·Al₂O₃, CaO·2Al₂O₃, or any combination thereof.

8. A method comprising:
introducing a hydrocarbon feedstock, an oxygen-containing gas, and, optionally, steam into a reactor, wherein the reactor comprises:
a pressure vessel with an interior wall;
a refractory lining inside the reactor, wherein the refractory lining comprises:
a first layer comprising a brick refractory,
a second layer comprising a refractory castable, wherein the refractory castable comprises an aggregate and a binder, wherein the binder comprises CaO·6Al₂O₃ and less than 1 wt % of a hydratable calcium aluminate, and
a third layer comprising a fiber refractory, wherein the second layer is between the first and third layers, and wherein the third layer is closest to the interior wall; and
reacting the hydrocarbon feedstock, the oxygen-containing gas, and the steam, if present, in the reactor to produce a product.

9. The method of claim 8, wherein the binder further comprises sodium hexametaphosphate, monoaluminate phosphate, alpha-alumina (α-Al₂O₃), or any combination thereof.

10. The method of claim 8, wherein the binder is present at 40 wt % or less of the refractory castable.

11. The method of claim 8, wherein the aggregate comprises CaO·6Al₂O₃, hibonite, bubble alumina, or any combination thereof.

12. The method of claim 8, wherein the binder comprises less than 0.1 wt % of the hydratable calcium aluminate.

13. The method of claim 8, wherein the binder is absent the hydratable calcium aluminate.

14. The method of claim 8, wherein the hydratable calcium aluminate comprises CaO·Al₂O₃, CaO·2Al₂O₃, or any combination thereof.

15. A refractory castable comprising:
an aggregate; and
a binder that comprises CaO·6Al₂O₃ and less than 1 wt % of a hydratable calcium aluminate.

16. The refractory castable of claim 15, wherein the binder further comprises sodium hexametaphosphate, monoaluminate phosphate, alpha-alumina (α-Al₂O₃), or any combination thereof.

17. The refractory castable of claim 15, wherein the binder is present at 40 wt % or less of the refractory castable.

18. The refractory castable of claim 15, wherein the aggregate comprises CaO·6Al₂O₃, hibonite, bubble alumina, or any combination thereof.

19. The refractory castable of claim 15, wherein the binder comprises less than 0.1 wt % of the hydratable calcium aluminate.

20. The refractory castable of claim 15, wherein the binder is absent the hydratable calcium aluminate.
